(19) United States
(12) Patent Application Publication
(10) Pub. No.: US 2026/0164348 A1
(43) Pub. Date: Jun. 11, 2026

(54) REDIRECTION BETWEEN TERRESTRIAL NETWORK AND NON-TERRESTRIAL NETWORK

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/388,936

(22) Filed: Nov. 13, 2025

Related U.S. Application Data
(60) Provisional application No. 63/729,111, filed on Dec. 6, 2024.
(60) Provisional application No. 63/737,244, filed on Dec. 20, 2024.
(60) Provisional application No. 63/742,715, filed on Jan. 7, 2025.
(60) Provisional application No. 63/745,103, filed on Jan. 14, 2025.

(51) Int. Cl. H04W 48/20; H04W 76/27; H04W 84/06

(52) U.S. Cl. CPC H04W 48/20; H04W 76/27; H04W 84/06

(57) ABSTRACT

A user equipment (UE) includes a transceiver configured to receive, from a terrestrial network (TN), a radio resource control (RRC) release message including an indication for a frequency for redirection from the TN to a non-terrestrial network (NTN). The UE also includes a processor operably coupled to the transceiver. The processor is configured to (i) in response to receiving the RRC release message, initiate an RRC release procedure to enter an RRC idle state, and (ii) perform a cell selection procedure that includes detecting NTN cells on the indicated frequency based on NTN assistance information associated to the indicated frequency. The NTN assistance information is included in one of (i) the RRC release message, or (ii) system information (SI).

### CROSS-REFERENCE TO RELATED APPLICATION(S) AND CLAIM OF PRIORITY

This application claims priority under 35 U.S.C. § 119(e) to U.S. Provisional Ser. No. 63/729,111 filed on Dec. 6, 2024, U.S. Provisional Ser. Nos. 63/737,244 filed on Dec. 20, 2024, 63/742,715 filed on Jan. 7, 2025, and 63/745,103 filed on Jan. 14, 2025. The above-identified provisional patent applications are hereby incorporated by reference in their entirety.

### TECHNICAL FIELD

This disclosure relates generally to wireless networks. More specifically, this disclosure relates to redirection between terrestrial networks (TNs) and non-terrestrial networks (NTNs).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for redirection between TNs and NTNs.

In one embodiment, a user equipment (UE) is provided. The UE includes a transceiver configured to receive, from a terrestrial network (TN), a radio resource control (RRC) release message including an indication for a frequency for redirection from the TN to a non-terrestrial network (NTN). The UE also includes a processor operably coupled to the transceiver. The processor is configured to (i) in response to receiving the RRC release message, initiate an RRC release procedure to enter an RRC idle state, and (ii) perform a cell selection procedure that includes detecting NTN cells on the indicated frequency based on NTN assistance information associated to the indicated frequency. The NTN assistance information is included in one of (i) the RRC release message, or (ii) system information (SI).

In another embodiment, a base station (BS) is provided. The BS includes a processor, and a transceiver operably coupled to the processor. The transceiver is configured to (i) transmit, to a UE, a RRC release message including an indication for a frequency for redirection from a TN to a NTN, and (ii) transmit, to the UE, NTN assistance information associated to the indicated frequency. The NTN assistance information is included in one of (i) the RRC release message, or (ii) SI.

In yet another embodiment, a method of operating a UE is provided. The method includes (i) receiving, from a TN, an RRC release message including an indication for a frequency for redirection from the TN to an NTN, and (ii) in response to receiving the RRC release message, initiating an RRC release procedure to enter an RRC idle state. The method also includes (iii) performing a cell selection procedure that includes detecting NTN cells on the indicated frequency based on NTN assistance information associated to the indicated frequency. The NTN assistance information is included in one of (i) the RRC release message, or (ii) SI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for redirection to an NTN by receiving NTN assistance information according to embodiments of the present disclosure;

FIG. 5 illustrates an example procedure for redirection to an NTN by acquiring a SIB with NTN assistance information according to embodiments of the present disclosure;

FIG. 6 illustrates an example procedure for redirection to an indicated NTN band by acquiring a SIB with NTN assistance information according to embodiments of the present disclosure;

FIG. 7 illustrates an example procedure for redirection to an NTN utilizing system information according to embodiments of the present disclosure;

FIG. 8 illustrates an example procedure for redirection to an indicated NTN band utilizing system information according to embodiments of the present disclosure;

FIG. 9 illustrates an example method for redirection between TNs and NTNs according to embodiments of the present disclosure; and

FIG. 10 illustrates another example method for redirection between TNs and NTNs according to embodiments of the present disclosure.

### DETAILED DESCRIPTION

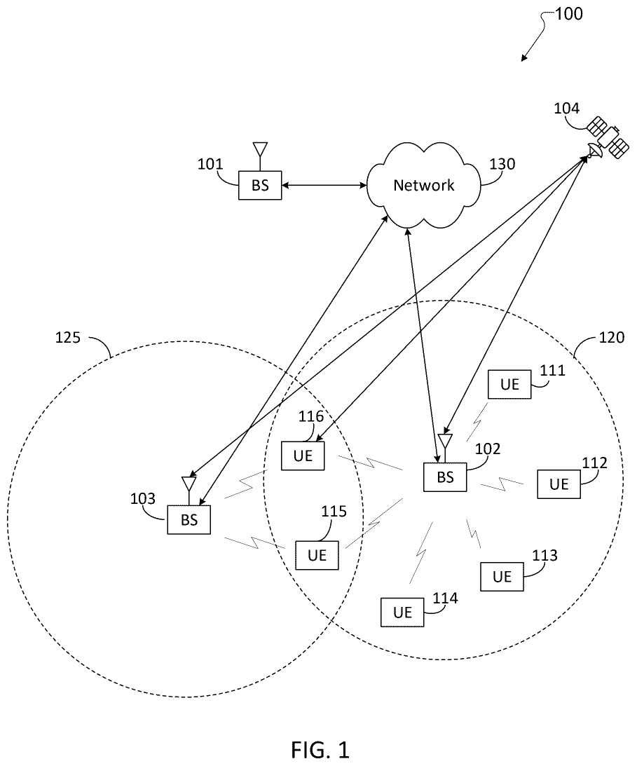

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5 G/NR communication systems.

In addition, in 5 G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP, TS 38.300v 18.3.0, “5G; NR; NR and NG-RAN Overall Description; Stage 2;” [2] 3GPP, TS 38.331 v18.3.0, “5G; NR; Radio Resource Control (RRC); Protocol specification;” [3] 3GPP, TS 38.321 v18.3.0 , “NR; Medium Access Control (MAC) protocol specification;” and [4] 3GPP, TS 38.304 v18.3.0 , “NR; User Equipment (UE) procedures in Idle mode and RRC Inactive state”.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to common fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Taking into account the capabilities of providing wide coverage and reliable service, an NTN is envisioned to ensure service availability and continuity ubiquitously. For instance, an NTN can support communication services in unserved areas that cannot be covered by other terrestrial networks (TNs), in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof to support redirection between TNs and NTNs. In certain embodiments, one or more of the BSs 101-103 include circuitry, programing, or a combination thereof to support redirection between TNs and NTNs.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

Throughout this disclosure the terms satellite or serving gNB are used interchangeably to refer to any component (or collection of components) configured to provide remote terminals with wireless access to a network (e.g., the network 130). Descriptions directly apply to satellite network architectures with transparent payload and with non-transparent payload, and to any aerial platforms such as unmanned aerial service (UAS) platforms, as well as to terrestrial networks.

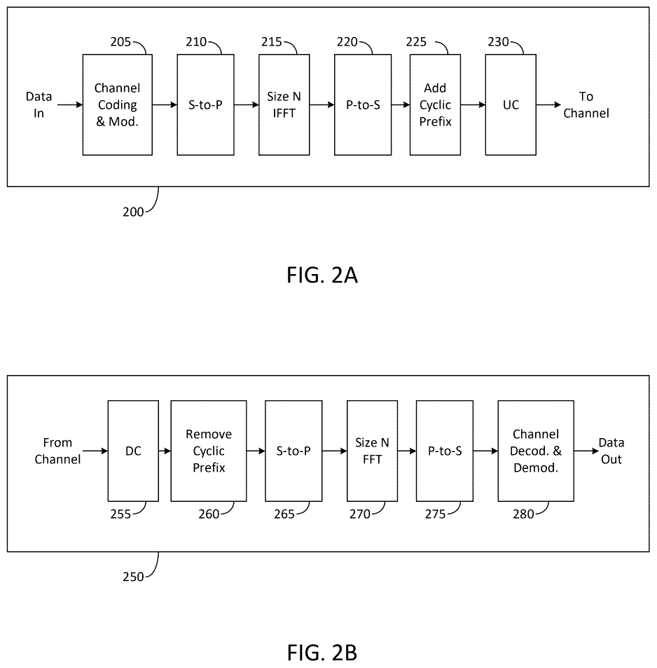

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support redirection between TNs and NTNs as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

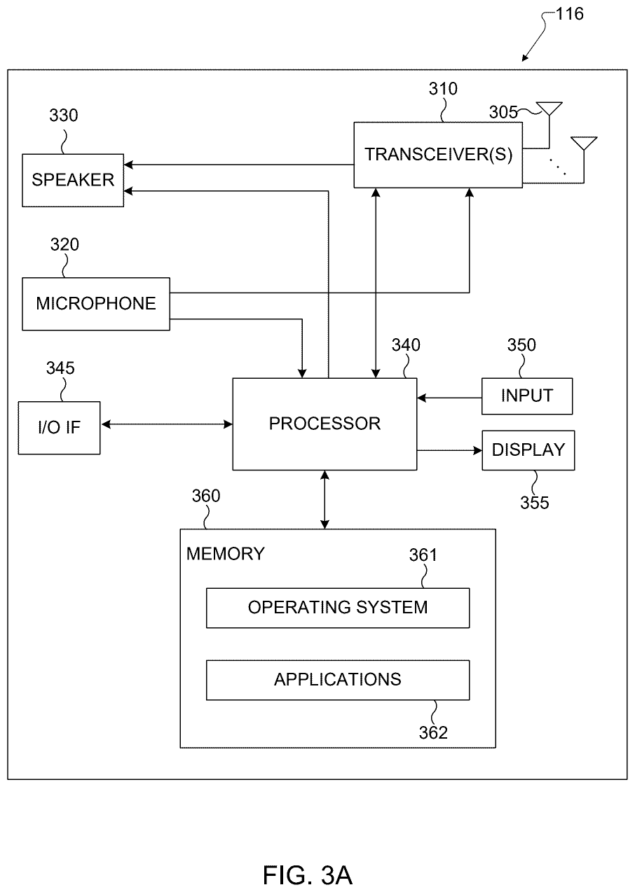

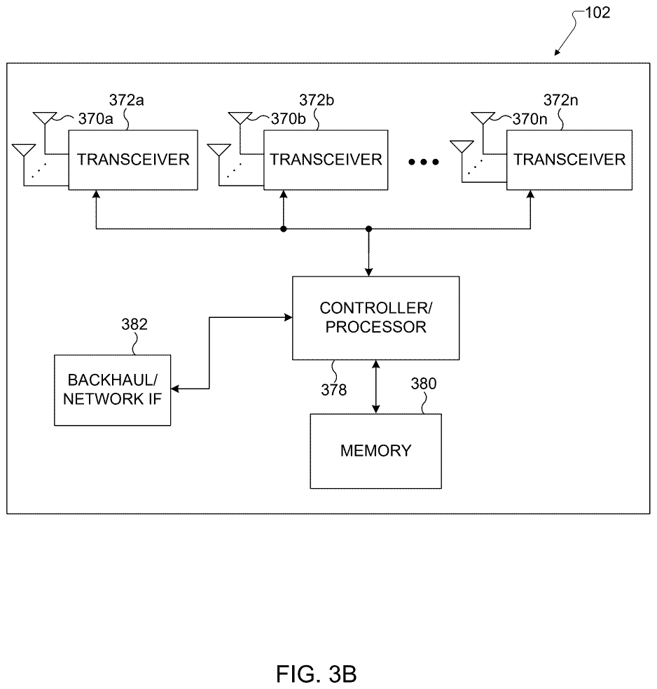

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for redirection between TNs and NTNs as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support redirection between TNs and NTNs as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

The Third-Generation Partnership Project (3GPP) has developed technical specifications and standards to define 5G radio-access technology, known as 5G New Radio (NR). In Release 17 of the 5G NR specifications, non-terrestrial networks (NTNs) are supported as a vertical functionality by 5G NR. An NTN provides non-terrestrial NR access to a UE by means of an NTN payload (e.g., a satellite), and an NTN Gateway. The NTN payload transparently forwards the radio protocol received from the UE (via the service link, [i.e., a wireless link between the NTN payload and UE such as shown between UE 116 and satellite(s} 104]) to the NTN Gateway (via the feeder link, [i.e., a wireless link between the NTN Gateway and the NTN payload such as shown between gNB 102 and satellite(s) 104]) and vice-versa. Considering an NTNs'capabilities of providing wide coverage and reliable service, NTNs are envisioned to improve service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc. It is desirable to enhance support of NTNs in 5G NR by introducing or enhancing various features to accommodate the different aspects of radio access to NTNs that are different from terrestrial networks (TNs) such as large cell coverage, long propagation delay, and non-static cells/satellites.

In an NTN, the NTN payload can be in geosynchronous orbit (GSO) (i.e., Earth-centered orbit at approximately 35786 kilometers above Earth's surface and synchronized with the Earth's rotation), or non-geosynchronous orbit (NGSO) (i.e., Low Earth Orbit [LEO] at an altitude approximately between 300 km and 1500 km and Medium Earth Orbit [MEO] at an altitude approximately between 7000 km and 25000 km). Depending on different NTN payloads, three types of service links are presently supported:
Earth-fixed: provisioned by beam(s) continuously covering the same geographical areas all the time (e.g., the case of GSO satellites)
Quasi-Earth-fixed: provisioned by beam(s) covering one geographic area for a limited period and a different geographic area during another period (e.g., the case of NGSO satellites generating steerable beams)
Earth-moving: provisioned by beam(s) whose coverage area slides over the Earth surface (e.g., the case of NGSO satellites generating fixed or non-steerable beams).

However, it should be understood that the various embodiments of the present disclosure are not limited to the types of service links above, and may be implemented over any type of existing or later developed service link.

With NGSO satellites, the gNB can provide either quasi-Earth-fixed cell coverage or Earth-moving cell coverage, while a gNB operating with a GSO satellite can provide Earth fixed cell coverage. Due to different properties of GSO and NGSO, different types of cells can be supported in an NTN, which are the earth-fixed cell, the quasi-earth-fixed cell, and the earth-moving cell. For a certain type of NTN payload/cell, it is desirable for the UE to support specific features or functionalities for radio access.

Load balancing can be achieved in NR with redirection mechanisms upon RRC release. In the RRCRelease message, the network (NW) provides frequency information to redirect the UE to the indicated frequency, and the UE performs an RRC release procedure and cell selection on the indicated frequency. It is desirable to support redirection from an NR TN to an NR NTN or from an NR NTN to an NR TN. Various embodiments of the present disclosure provide procedures and information to facilitate such redirection.

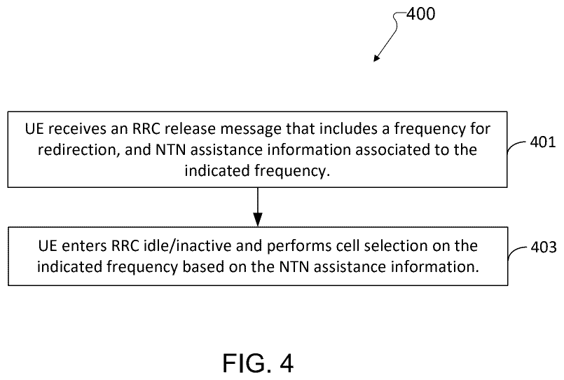

In some embodiments, assistance information for redirection to an NTN can be provided by the network. For example, in embodiments such as these, the base station can transmit an RRC release message to a UE that includes a carrier frequency indicating a redirected frequency and NTN assistance information associated to the redirected frequency, similar as shown in FIG. 4.

FIG. 4 illustrates an example procedure for redirection to an NTN by receiving NTN assistance information 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for redirection to an NTN by receiving NTN assistance information could be used without departing from the scope of this disclosure.

In the example of FIG. 4, the procedure 400 begins at operation 401. At operation 401, a UE (such as UE 116) receives (for example, from network 100 via gNB 102) an RRC release message that includes a frequency for redirection, and NTN assistance information associated to the indicated frequency. At operation 403, the UE enters an RRC idle or RRC inactive state and performs cell selection on the indicated frequency based on the NTN assistance information.

In some embodiments, (for example, at operation 401), the assistance information for one or multiple satellites (for example satellite(s) 104) or neighbor cells in the RRC release message can include, for each neighbor cell or satellite, physical cell identity (PCI), and/or satellite ephemeris information, and/or common timing advance (TA) information, and/or epoch time for the ephemeris information and/or the common TA information, and/or validity duration for the ephemeris information and/or the common TA information and/or polarization information.

In some embodiments, NTN assistance information can be provided in an ntn-Config information element (IE) in the RRC release message. In embodiments such as these, the IE ntn-Config IE can include one or more of the following items:
The satellite ephemeris information can be provided either in a format of position and velocity state vector in the Earth-center, Earth fixed coordinate system (ECEF) or in a format of orbital parameters in Earh-centered inertial coordinate (ECI). Note: The ECI and ECEF coincide at epochTime (i.e., the x, y, z axes in ECEF are aligned with the x, y, z axes in ECI at epochTime).
The common TA information can include a common TA that indicates a network-controlled common timing advance value, and it may include any timing offset considered necessary by the network, a drift rate of the common TA, and a drift rate variation of the common TA.
The epoch time is used to indicate the epoch time for the NTN assistance information, and it is defined as the starting time of a DL sub-frame, indicated by a system frame number (SFN) and a sub-frame number signaled together with the assistance information. The reference point for EpochTime of the serving, target, or neighbor NTN payload ephemeris and Common TA parameters is the uplink time synchronization reference point when this field is provided in an NTN cell and the gNB when this field is provided in a TN cell. In case of handover or conditional handover, EpochTime is based on the timing of the target cell (i.e., the SFN and sub-frame number indicated refers to the SFN and sub-frame of the target cell). Otherwise, EpochTime is used based on the timing of the serving cell (i.e., the SFN and sub-frame number indicated refers to the SFN and sub-frame of the serving cell). In some embodiments, presence of this field may be mandatory when ntn-Config is provided in a dedicated configuration.
A validity duration configured by the network for assistance information (i.e., Serving and/or neighbor satellite ephemeris and Common TA parameters) which indicates the maximum time duration (from epochTime) during which the UE can apply assistance information without having acquired new assistance information. In some embodiments, presence of this field may be mandatory when ntn-Config is provided in a dedicated configuration. In some embodiments, presences of this field can be optional in a dedicated configuration. If this field is absent in ntn-Config provided via an RRC release message in a TN cell, how the UE sets the validity duration is left to UE implementation.
The polarization of DL indicates polarization information for downlink transmission on the service link: including Right hand, Left hand circular polarizations (RHCP, LHCP) and Linear polarization. The polarization of UL, if present, indicates the polarization information for the uplink service link. If the polarization of UL is not present and the polarization of DL is present, the UE assumes the same polarization for UL and DL.
Satellite ID is used to identify the satellite assistance information of the serving or neighbor satellites.

In some other embodiments, these items, as assistance information for NTN access, can be provided in system information (e.g., SIB19) of a TN cell.

In some embodiments, (for example, at operation 403), upon the reception of the RRC release message, if the RRC release message includes the NTN assistance information (e.g., an ntn-Config IE), the UE stores the NTN assistance information, and enters an RRC inactive state if suspend configuration is included in the RRC release message. Otherwise, the UE enters an RRC idle state, and performs cell selection.

Although FIG. 4 illustrates one example procedure for redirection to an NTN by receiving NTN assistance information 400, various changes may be made to FIG. 4. For example, while shown as a series of operations, various operations in FIG. 4 could overlap, occur in parallel, occur in a different order, occur any number of times, be omitted, or replaced by other operations.

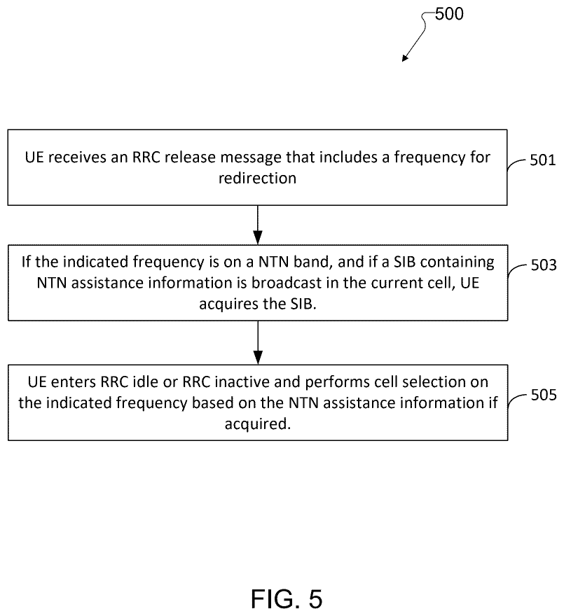

In some embodiments, a base station transmits an RRC release message to a UE that includes a carrier frequency indicating a redirected frequency, and the base station broadcasts a SIB (e.g., SIB19) that contains NTN assistance information, similar as shown in FIG. 5.

FIG. 5 illustrates an example procedure for redirection to an NTN by acquiring a SIB with NTN assistance information 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for redirection to an NTN by acquiring a SIB with NTN assistance information could be used without departing from the scope of this disclosure.

In the example of FIG. 5, the procedure 500 begins at operation 501. At operation 501, a UE (such as UE 116) receives (for example, from wireless network 100 via gNB 102) an RRC release message that includes a frequency for redirection. At operation 503, if the indicated frequency is on an NTN band, and if a SIB (e.g., SIB19) containing NTN assistance information (e.g., ntn-Config including satellite ephemeris, common TA, etc., as aforementioned) is broadcast in the current cell, the UE acquires the SIB and/or stores the NTN assistance information. At operation 505, the UE enters an RRC inactive state if suspend configuration is included in the RRC release message. Otherwise, the UE enters an RRC idle state and performs cell selection on the indicated frequency based on the NTN assistance information if acquired.

Although FIG. 5 illustrates one example procedure for redirection to an NTN by receiving NTN assistance information 500, various changes may be made to FIG. 5. For example, while shown as a series of operations, various operations in FIG. 5 could overlap, occur in parallel, occur in a different order, occur any number of times, be omitted, or replaced by other operations.

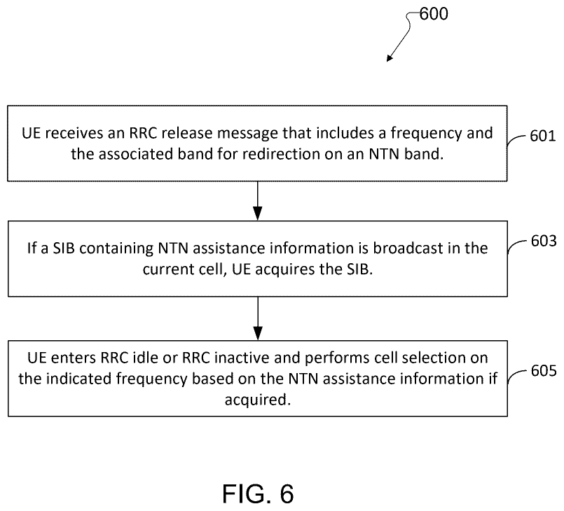

In some embodiments, a base station transmits an RRC release message to a UE that includes a carrier frequency indicating a redirected frequency and a frequency band indicator indicating an NTN band, and the base station broadcasts a SIB (e.g., SIB19) that contains NTN assistance information, similar as shown in FIG. 6.

FIG. 6 illustrates an example procedure for redirection to an indicated NTN band by acquiring a SIB with NTN assistance information 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for redirection to an indicated NTN band by acquiring a SIB with NTN assistance information could be used without departing from the scope of this disclosure.

In the example of FIG. 6, the procedure 600 begins at operation 601. At operation 601, a UE (such as UE 116) receives (for example, from wireless network 100 via gNB 102) an RRC release message that includes a frequency and the associated band indicator for redirection on an NTN band. At operation 603, if a SIB (e.g., SIB19) containing NTN assistance information (e.g., ntn-Config including satellite ephemeris, common TA, etc., as aforementioned) is broadcast in the current cell, the UE acquires the SIB and/or stores the NTN assistance information. At operation 605, the UE enters an RRC inactive state if suspend configuration is included in the RRC release message. Otherwise, the UE enters an RRC idle state and performs cell selection on the indicated frequency based on the NTN assistance information if acquired.

Although FIG. 6 illustrates one example procedure for redirection to an indicated NTN band by acquiring a SIB with NTN assistance information 600, various changes may be made to FIG. 6. For example, while shown as a series of operations, various operations in FIG. 6 could overlap, occur in parallel, occur in a different order, occur any number of times, be omitted, or replaced by other operations.

In some embodiments (for example, at operation 503 and/or operation 603), if a SIB (e.g., SIB19) containing NTN assistance information (e.g., ntn-Config including satellite ephemeris, common TA, etc., as aforementioned) is broadcast in the current cell, and if the UE has not acquired the SIB, the UE may perform an SI acquisition procedure to acquire the SIB containing the NTN assistance information.

In some embodiments (for example, at operation 503 and/or operation 603), if the active bandwidth part (BWP) is configured with a common search space, the UE may perform an SI acquisition procedure to acquire the SIB containing the NTN assistance information. Otherwise (i.e., the active BWP is not configured with a common search space), they UE may switch to a BWP with a common search space and perform an SI acquisition procedure to acquire the SIB containing the NTN assistance information.

In some embodiments (for example, at operation 503 and/or operation 603), upon receiving a SIB (e.g., SIB19) containing NTN assistance information, the UE may start or restart a timer T430 with the timer value set to the indicated validity duration from the subframe indicated by epoch time for the NTN assistance information. In embodiments such as these, the UE can attempt to re-acquire the SIB before the end of the duration indicated by the validity duration and epoch time by UE implementation.

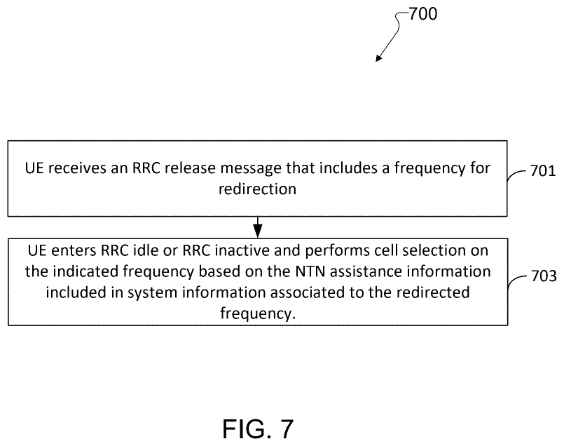

In some embodiments, a base station transmits to an RRC release message to a UE that includes a carrier frequency indicating a redirected frequency and broadcasts a SIB (e.g., SIB19) that contains NTN assistance information, similar as shown in FIG. 7.

FIG. 7 illustrates an example procedure for redirection to an NTN utilizing system information 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for redirection to an NTN by utilizing system information could be used without departing from the scope of this disclosure.

In the example of FIG. 7, the procedure 700 begins at operation 701. At operation 701, a UE (such as UE 116) receives (for example, from wireless network 100 via gNB 102) an RRC release message that includes a frequency for redirection. At operation 703, if the indicated frequency is on an NTN band, and if the system information (e.g., SIB19) provides NTN assistance information (e.g., satellite ephemeris, common TA, satellite ID, etc. as aforementioned) associated to one or more neighbor cells on the same frequency as the redirected frequency, and if UE has acquired the system information (e.g., SIB19) and/or stored a valid version of the system information (e.g., SIB19), the UE enters an RRC inactive state if suspend configuration is included in the RRC release message. Otherwise, the UE enters an RRC idle state and performs cell selection on the indicated redirected frequency based on the NTN assistance information included in the system information.

Although FIG. 7 illustrates one example procedure for redirection to an NTN by utilizing system information 700, various changes may be made to FIG. 7. For example, while shown as a series of operations, various operations in FIG. 7 could overlap, occur in parallel, occur in a different order, occur any number of times, be omitted, or replaced by other operations.

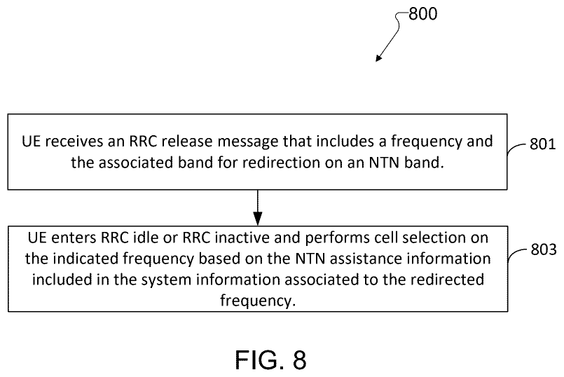

In some embodiments, a base station transmits an RRC release message to a UE that includes a carrier frequency indicating a redirected frequency and a frequency band indicator indicating an NTN band, and the base station broadcasts a SIB (e.g., SIB19) that contains NTN assistance information, similar as shown in FIG. 8.

FIG. 8 illustrates an example procedure for redirection to an indicated NTN band utilizing system information 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for redirection to an indicated NTN band by utilizing system information could be used without departing from the scope of this disclosure.

In the example of FIG. 8, the procedure 800 begins at operation 801. At operation 801, a UE (such as UE 116) receives (for example, from wireless network 100 via gNB 102) an RRC release message that includes a frequency and the associated band indicator for redirection on an NTN band. At operation 803, if the system information (e.g., SIB19) provides NTN assistance information (e.g., satellite ephemeris, common TA, satellite ID, etc. as aforementioned) associated to one or more neighbor cells on the frequency same as the redirected frequency, and if UE has acquired the system information (e.g., SIB19) and/or stored a valid version of the system information (e.g., SIB19), the UE enters an RRC inactive state if suspend configuration is included in the RRC release message. Otherwise, the UE enters an RRC idle state and performs cell selection on the indicated redirected frequency based on the NTN assistance information included in the system information.

Although FIG. 8 illustrates one example procedure for redirection to an indicated NTN band by utilizing system information 800, various changes may be made to FIG. 8. For example, while shown as a series of operations, various operations in FIG. 8 could overlap, occur in parallel, occur in a different order, occur any number of times, be omitted, or replaced by other operations.

In some embodiments, where a UE (such as UE 116) receives (for example, from wireless network 100 via gNB 102) an RRC release message that indicates a redirected frequency, the UE may perform the following operations:
If NTN assistance information (e.g., satellite ephemeris, common TA, satellite ID, etc. as aforementioned) is included in the RRC release message for the redirected frequency, the UE enters an RRC inactive period if suspend configuration is included in the RRC release message. Otherwise, the UE enters an RRC idle state and performs cell selection on the indicated redirected frequency based on the NTN assistance information included in RRC release message.
If a redirected frequency is included in the RRC release message (where the redirected frequency can be on a certain TN or NTN band), or if the redirected frequency included in the RRC release message is on an NTN frequency band, or if a frequency band indicator of NTN bands is included in the RRC release message for the redirected frequency, if system information (e.g., SIB19) of the current cell provides NTN assistance information (e.g., satellite ephemeris, common TA, satellite ID, etc. as aforementioned) associated to one or more neighbor cells on the frequency same as the redirected frequency:
   If the UE has acquired the system information (e.g., SIB19) and/or stored a valid version of the system information (e.g., SIB19), the UE enters an RRC inactive state if suspend configuration is included in the RRC release message. Otherwise, the UE enters an RRC idle state and performs cell selection on the indicated redirected frequency based on the NTN assistance information included in system information.
   Otherwise, the UE performs an SI acquisition procedure to acquire the system information containing the NTN assistance information. The UE enters an RRC inactive state if suspend configuration is included in the RRC release message.
   Otherwise, the UE enters an RRC idle state and performs cell selection on the indicated redirected frequency based on the NTN assistance information included in system information.

In some embodiments, where a UE (such as UE 116) receives (for example, from wireless network 100 via gNB 102) an RRC release message that indicates a redirected frequency, the UE may perform the following operations:
If NTN assistance information (e.g., satellite ephemeris, common TA, satellite ID, etc. as aforementioned) is included in the RRC release message for the redirected frequency, the UE enters an RRC inactive state if suspend configuration is included in the RRC release message. Otherwise, the UE enters an RRC idle state and performs cell selection on the indicated redirected frequency based on the NTN assistance information included in the RRC release message.
If a redirected frequency is included in the RRC release message (where the redirected frequency can be on a certain TN or NTN band), or if the redirected frequency is on an NTN band, or if a frequency band indicator of NTN bands is included in the RRC release message for the redirected frequency:
   If the UE has acquired and/or stored the system information (e.g., SIB19) that contains the NTN assistance information associated to the redirected frequency, the UE enters an RRC inactive state if suspend configuration is included in the RRC release message. Otherwise (i.e., if suspend configuration is not included) the UE enters an RRC idle state and performs cell selection on the indicated redirected frequency based on the NTN assistance information included in system information.
   Otherwise, the UE enters an RRC inactive state if suspend configuration is included in the RRC release message. Otherwise (i.e., if suspend configuration is not included) the UE enters an RRC idle state and performs cell selection. If the selected cell broadcast the SIB (e.g., SIB19) that contains NTN assistance information, for example the selected cell is an NTN cell, the UE acquires a master information block (MIB), SIB1 and/or the SIB (e.g., SIB19) that contains NTN assistance information to access the selected cell.

In some embodiments, a UE capability indication may indicate that the UE supports redirection from a TN to an NTN. For example, a UE supporting indicating support for redirection from a TN to an NTN may support NTNs. In some embodiments, this capability may be applicable only if the UE supports NTNs. In some embodiments, a UE supporting indicating support for redirection from a TN to an NTN supports, in an RRC_CONNECTED state in a TN cell, the reception of SIB19 to acquire satellite assistance information for NTN access. In some embodiments, a UE supporting indicating support for redirection from a TN to an NTN can support, in an RRC_IDLE or in RRC_INACTIVE state in a TN, cell the measurement of NTN neighbour cells for cell selection and/or cell reselection based on the information acquired in SIB19. In some embodiments, this UE capability can be per UE or per frequency or per frequency combination (e.g., a combination of a TN frequency and an NTN frequency). In some embodiments, the UE capability can be different for TDD and FDD, and/or different from FR1 and FR2. In some embodiments, a UE can report support for redirection from a TN to an NTN by including an indication in a UECapabilityInformation message and sending the UECapabilityInformation message to the network, which may be a response to a UECapabilityEnquiry message received from the network.

In some embodiments, a UE in an RRC_CONNECTED state may acquire system information (e.g., SIB19) that provides NTN assistance information (e.g., satellite ephemeris, common TA, satellite ID, etc. as aforementioned) if the current cell in the TN provides this system information and if the UE supports NTNs and/or supports redirection from a TN to an NTN. An example procedure for such embodiments may be as follows:

1. For a UE in an RRC_CONNECTED state, if the current cell provides a SIB (e.g., SIB 19) that includes NTN-specific assistance information (e.g., satellite ephemeris, common TA, satellite ID, etc. as aforementioned),
if the active BWP is configured with a common search space (CSS), the UE acquires the SIB based on the SI scheduling information in SIB1;
if the active BWP is not configured with a CSS for the UE, the NW transmits an RRC reconfiguration message with dedicated SI delivery of the SIB (e.g., SIB19) and the UE receives the SIB (e.g., SIB19) via the dedicated delivery; alternatively, the UE sends a request for the SIB (e.g., SIB19) and the NW transmits an RRC reconfiguration message with dedicated SI delivery of the SIB (e.g., SIB19) as a response to the request, and the UE receives the SIB (e.g., SIB19).
Upon receiving the SIB (e.g., SIB19) in an NTN cell, the UE in an RRC_CONNECTED state starts or restarts a timer (e.g., denoted T430) for the serving cell with the timer value set to the validity duration (e.g., indicated by RRC parameter ntn-UlSyncValidityDuration) for the serving cell from the subframe indicated by the epoch time (e.g., indicated by an RRC parameter epochTime) for the serving cell. The UE maintains the validity of the SIB (e.g., SIB19) and attempts to re-acquire the SIB (e.g., SIB19) before the end of the validity duration indicated by UE implementation.

2. The NW transmits an RRC release message that includes a frequency for redirection. In some embodiments, the RRC release message includes a frequency band indicator for the redirected frequency. The frequency band indicator can indicate an NTN band for the redirected frequency. In some embodiments, the RRC release message includes NTN assistance information (e.g., satellite ephemeris, common TA, satellite ID, etc. as aforementioned) in the RRC release message for the redirected frequency.

3. The UE receives the RRC release message and performs an RRC release procedure.
If NTN assistance information (e.g., satellite ephemeris, common TA, satellite ID, etc. as aforementioned) is included in the RRC release message for the redirected frequency,
   the UE enters an RRC inactive state if suspend configuration is included in the RRC release message. Otherwise (i.e., if suspend configuration is not included) the UE enters an RRC idle state and performs cell selection on the indicated redirected frequency based on the NTN assistance information associated to the redirected frequency included in RRC release message.
If a redirected frequency is included in the RRC release message (where the redirected frequency can be on a certain TN or NTN band), or if the redirected frequency included in the RRC release message is on an NTN frequency band, and/or if a frequency band indicator of NTN bands is included in the RRC release message for the redirected frequency,
   if the UE has acquired and/or stored a valid system information (e.g., SIB19) containing the NTN assistance information that is associated to one or more neighbor cells on the same frequency as the redirected frequency,
      the UE enters an RRC inactive mode if suspend configuration is included in the RRC release message. Otherwise (i.e., if suspend configuration is not included) the UE enters an RRC idle state and performs cell selection on the indicated redirected frequency based on the NTN assistance information associated to the redirected frequency included in system information.

In some embodiments, the network may transmit an RRCRelease message to the UE including redirection information. In embodiments such as these, the redirection information can include a frequency band indicator that indicates a TN band and/or an NTN band.

In some embodiments, at reception of an RRCRelease message to transition the UE to RRC_IDLE or RRC_INACTIVE, the UE can attempt to camp on a suitable cell according to redirectedCarrierInfo if included in the RRCRelease message, which can include a frequency band indicator for TN and/or NTN frequency band and/or NTN assistance information associated to the indicated frequency for redirection. In embodiments such as these, the UE can attempt to find a suitable cell based on the NTN frequency band indicator in the RRC release message and/or based on the NTN assistance information associated to the indicated frequency if provided in the RRC release message or if acquired via system information. If the UE cannot find a suitable cell, the UE may camp on any suitable cell of the indicated RAT. If the RRCRelease message does not contain the redirectedCarrierInfo, the UE attempts to select a suitable cell on an NR carrier. If no suitable cell is found according to the above, the UE performs cell selection using stored information in order to find a suitable cell to camp on.

In some embodiments, when returning to an RRC_IDLE state after the UE moves to an RRC_CONNECTED state from a camped on any cell state, the UE can attempt to camp on an acceptable cell according to redirectedCarrierInfo, if included in the RRCRelease message, which can include a frequency band indicator for TN and/or NTN frequency band and/or NTN assistance information associated to the indicated frequency for redirection. In embodiments such as these, the UE can attempt to find a suitable cell based on the NTN frequency band indicator in the RRC release message and/or based on the NTN assistance information associated to the indicated frequency if provided in the RRC release message or if acquired via system information. If the UE cannot find an acceptable cell, the UE may camp on any acceptable cell of the indicated RAT. If the RRCRelease message does not contain redirectedCarrierInfo, the UE attempts to select an acceptable cell on an NR frequency. If no acceptable cell is found according to the above, the UE not operating in standalone non-public network (SNPN) Access Mode continues to search for an acceptable cell of any PLMN in the state any cell selection. If no acceptable cell is found according to the above, the UE in SNPN access mode continues to search for an acceptable cell of any SNPN in the state any cell selection.

In some embodiments, an RRCRelease message as described herein can be signalled as follows:

### RRCRelease

The RRCRelease message is used to command the release of an RRC connection or the suspension of the RRC connection.
Signalling radio bearer: SRB1
RLC-SAP: AM
Logical channel: DCCH
Direction: Network to UE

### RRCRelease Message

RRCRelease message

-- ASN1START
-- TAG-RRCRELEASE-START

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| | |
|---|---|
| RRCRelease-IEs ::= | SEQUENCE { |
| redirectedCarrierInfo | RedirectedCarrierInfo |

OPTIONAL, -- Need N

| | |
|---|---|
| cellReselectionPriorities | CellReselectionPriorities |

OPTIONAL, -- Need R

| | |
|---|---|
| suspendConfig | SuspendConfig |

OPTIONAL, -- Need R

| | |
|---|---|
| deprioritisationReq | SEQUENCE { |
| deprioritisationType | ENUMERATED {frequency, nr}, |
| deprioritisationTimer | ENUMERATED {min5, min10, min15, min30} |

| | |
|---|---|
| } | OPTIONAL, -- Need |

N

| | |
|---|---|
| lateNonCriticalExtension | OCTET STRING |

OPTIONAL,

| | |
|---|---|
| nonCriticalExtension | RRCRelease-v1540-IEs |

OPTIONAL
}

| | |
|---|---|
| RedirectedCarrierInfo ::= | CHOICE { |
| nr | CarrierInfoNR, |
| eutra | RedirectedCarrierInfo-EUTRA, |

...
}

| CarrierInfoNR ::= | SEQUENCE { | |
|---|---|---|
| carrierFreq | ARFCN-ValueNR, | |
| ssbSubcarrierSpacing | SubcarrierSpacing, | |
| smtc | SSB-MTC | OPTIONAL, -- |

```
Need S
    ...
    [[
```

| | |
|---|---|
| freqBandIndicatorNR | FreqBandIndicatorNR |

OPTIONAL -- Need R
]]
}

| | |
|---|---|
| FreqBandIndicatorNR ::= | INTEGER (1..1024) |

In some embodiments, redirection information can include a parameter carrierFreq that indicates the redirected NR frequency, and/or a parameter freqBandIndicatorNR that indicates an NR frequency band number.

In some embodiments, redirection information can include a parameter ssbSubcarrierSpacing that indicates the subcarrier spacing of the SSB in the redirected SSB frequency. In some embodiments, only the following values may be applicable depending on the used frequency: FR1 (or FR1-NTN): 15 or 30 kHz; FR2-1 (or FR2-NTN): 120 or 240 kHz; FR2-2: 120, 480, or 960 kHz.

In some embodiments, redirection information can include a parameter smtc that indicates the SSB periodicity/offset/duration configuration for the redirected SSB frequency. In embodiments such as these, the parameter is based on a timing reference of a PCell. If the field is absent, the UE uses the SMTC configured in the measObjectNR having the same SSB frequency and subcarrier spacing. If the field is broadcast by an NTN cell, the offset (derived from parameter periodicityAndOffset) is based on the assumption that the gNB-UE propagation delay difference between the serving cell and neighbour cells equals to 0 ms, and UE can adjust the actual offset based on the actual propagation delay difference.

In some embodiments, a UE in an RRC_CONNECTED state for which AS security has been activated with SRB2 and at least one DRB/multicast MRB setup may initiate the RRC re-establishment procedure in order to continue the RRC connection. In embodiments, such as these, upon initiation of the RRC re-establishment procedure, if the UE has acquired a SIB (e.g., SIB19) containing NTN assistance information (e.g., ntn-Config including satellite ephemeris, common TA, etc., as aforementioned) in the current cell, the UE can perform cell selection on NTN bands utilizing the NTN assistance information.

For any of the embodiments described herein, cell selection may be performed according to one of the following procedures:
a) Initial cell selection (no prior knowledge of which RF channels are NR frequencies):
   1. The UE scans all RF channels in the NR bands according to the UE's capabilities to find a suitable cell.
   2. On each frequency, the UE need only search for the strongest cell, except for operation with shared spectrum channel access where the UE may search for the next strongest cell(s).
   3. Once a suitable cell is found, this cell shall be selected.
b) Cell selection by leveraging stored information:
   1. This procedure uses stored information of frequencies and optionally also information on cell parameters or satellite parameters for NTN from previously received measurement control information elements or from previously detected cells or from previously acquired system information.
   2. Once the UE has found a suitable cell, the UE selects the suitable cell.
   3. If no suitable cell is found, the initial cell selection procedure in a) is started.

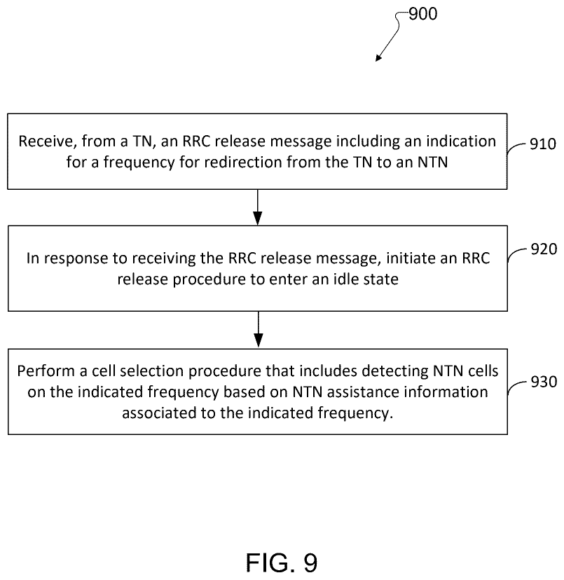

FIG. 9 illustrates an example method for redirection between TNs and NTNs 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method for redirection between TNs and NTNs could be used without departing from the scope of this disclosure.

In the example of FIG. 9, method 900 begins at step 910. At step 910, a UE (such as UE 116) receives from a TN (for example, from BS 102), an RRC release message including an indication for a frequency for redirection from the TN to an NTN.

At step 920, in response to receiving the RRC release message, the UE initiates an RRC release procedure to enter an RRC idle state.

At step 930, the UE performs a cell selection procedure that includes detecting NTN cells on the indicated frequency based on NTN assistance information associated to the indicated frequency. The NTN assistance information may be included in one of (i) the RRC release message, or (ii) SI.

In some embodiments, where the NTN assistance is included in SI, the UE may also acquire the SI including the NTN assistance information.

In some embodiments, the RRC release message may further include an indication that the indicated frequency is for an NTN frequency band. In embodiments such as these, the UE may detect the NTN cells on the indicated frequency based on the indication that the indicated frequency is for an NTN frequency band.

In some embodiments, the UE may perform the cell selection procedure for RRC re-establishment based on the NTN assistance information included in the SI.

In some embodiments, the NTN assistance information may include a list of one or more NTN access information elements. In embodiments such as these, the NTN access information elements may include at least one of satellite ephemeris information, common timing advance information, epoch time, validity duration, and NTN polarization information.

In some embodiments, the RRCE release message may further include at least one of synchronization signal block (SSB) subcarrier spacing for the indicated frequency, and an SSB measurement timing configuration (SMTC) for the indicated frequency. In embodiments such as these, the UE may detect SSBs of NTN cells on the indicated frequency based on the SSB subcarrier spacing and the SMTC.

In some embodiments, prior to receiving the RRC release message, the UE may transmit a message to the TN including an indication that the UE supports redirection from the TN to the NTN. In embodiments such as these, the RRC release message may include the frequency for redirection from the TN to the NTN in response to the message indicating that the UE supports redirection from the TN to the NTN.

Although FIG. 9 illustrates one example method for redirection between TNs and NTNs 900, various changes may be made to FIG. 9. For example, while shown as a series of steps, various steps in FIG. 9 could overlap, occur in parallel, occur in a different order, occur any number of times, be omitted, or replaced by other steps.

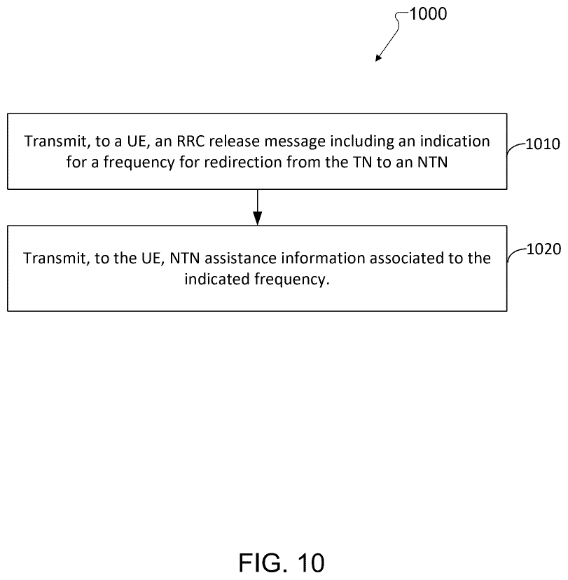

FIG. 10 illustrates an example method for redirection between TNs and NTNs 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for redirection between TNs and NTNs could be used without departing from the scope of this disclosure.

In the example of FIG. 10, method 1000 begins at step 1010. At step 1010, a BS (such as BS 102) transmits, to a UE (for example, UE 116), an RRC release message including an indication for a frequency for redirection from the TN to an NTN.

At step 1020, the UE transmits, to the UE, NTN assistance information associated to the indicated frequency. The NTN assistance information may be included in one of (i) the RRC release message, or (ii) SI.

In some embodiments, where the NTN assistance information is included in SI, the BS may transmit a SIB that includes the SI.

In some embodiments, the RRC release message may further include an indication that the indicated frequency is for an NTN frequency band.

In some embodiments, the NTN assistance information may include a list of one or more NTN access information elements. In embodiments such as these, the NTN access information elements may include at least one of satellite ephemeris information, common timing advance information, epoch time, validity duration, and NTN polarization information.

In some embodiments, the RRC release message may further include at least one of SSB subcarrier spacing for the indicated frequency, and an SMTC for the indicated frequency.

In some embodiments, prior to transmitting the RRC release message, the BS may receive a message from the UE including an indication that the UE supports redirection from the TN to the NTN. In embodiments such as these, the RRC release message includes the frequency for redirection from the TN to the NTN in response to the message indicating that the UE supports redirection from the TN to the NTN.

Although FIG. 10 illustrates one example method for redirection between TNs and NTNs 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompasses such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a terrestrial network (TN), a radio resource control (RRC) release message including an indication for a frequency for redirection from the TN to a non-terrestrial network (NTN); and
a processor operably coupled to the transceiver, the processor configured to:
in response to receiving the RRC release message, initiate an RRC release procedure to enter an RRC idle state; and
perform a cell selection procedure that includes detecting NTN cells on the indicated frequency based on NTN assistance information associated to the indicated frequency,
wherein the NTN assistance information is included in one of (i) the RRC release message, or (ii) system information (SI).

2. The UE of claim 1, wherein:
the NTN assistance information is included in SI; and
the processor is further configured to acquire the SI including the NTN assistance information.

3. The UE of claim 2, wherein:
the RRC release message further includes an indication that the indicated frequency is for an NTN frequency band; and
the processor is further configured to detect the NTN cells on the indicated frequency based on the indication that the indicated frequency is for the NTN frequency band.

4. The UE of claim 2, wherein the cell selection procedure is performed for RRC re-establishment based on the NTN assistance information included in the SI.

5. The UE of claim 1, wherein the NTN assistance information includes a list of one or more NTN access information elements, the NTN access information elements including at least one of:
satellite ephemeris information;
common timing advance information;
epoch time;
validity duration; and
NTN polarization information.

6. The UE of claim 1, wherein:
the RRC release message further includes at least one of:
synchronization signal block (SSB) subcarrier spacing for the indicated frequency; and
an SSB measurement timing configuration (SMTC) for the indicated frequency, and
the processor is further configured to detect SSBs of NTN cells on the indicated frequency based on the SSB subcarrier spacing and the SMTC.

7. The UE of claim 1, wherein:
the transceiver is further configured to, prior to receiving the RRC release message, transmit a message to the TN including an indication that the UE supports redirection from the TN to the NTN; and
the RRC release message includes the frequency for redirection from the TN to the NTN in response to the message indicating that the UE supports redirection from the TN to the NTN.

8. A base station (BS) comprising:
a processor; and
a transceiver operably coupled to the processor, the transceiver configured to:
transmit, to a user equipment (UE), a radio resource control (RRC) release message including an indication for a frequency for redirection from a terrestrial network (TN) to a non-terrestrial network (NTN); and
transmit, to the UE, NTN assistance information associated to the indicated frequency,
wherein the NTN assistance information is included in one of (i) the RRC release message, or (ii) system information (SI).

9. The BS of claim 8, wherein:
the NTN assistance information is included in SI; and
the transceiver is further configured to transmit a system information block (SIB) that includes the SI.

10. The BS of claim 9, wherein the RRC release message further includes an indication that the indicated frequency is for an NTN frequency band.

11. The BS of claim 8, wherein the NTN assistance information includes a list of one or more NTN access information elements, the NTN access information elements including at least one of:
satellite ephemeris information;
common timing advance information;
epoch time;
validity duration; and
NTN polarization information.

12. The BS of claim 8, wherein the RRC release message further includes at least one of:
synchronization signal block (SSB) subcarrier spacing for the indicated frequency; and
an SSB measurement timing configuration (SMTC) for the indicated frequency.

13. The BS of claim 8, wherein:
the transceiver is further configured to, prior to transmitting the RRC release message, receive a message from the UE including an indication that the UE supports redirection from the TN to the NTN; and
the RRC release message includes the frequency for redirection from the TN to the NTN in response to the message indicating that the UE supports redirection from the TN to the NTN.

14. A method of operating a user equipment (UE), the method comprising:
receiving, from a terrestrial network (TN), a radio resource control (RRC) release message including an indication for a frequency for redirection from the TN to a non-terrestrial network (NTN);
in response to receiving the RRC release message, initiating an RRC release procedure to enter an RRC idle state; and
performing a cell selection procedure that includes detecting NTN cells on the indicated frequency based on NTN assistance information associated to the indicated frequency,
wherein the NTN assistance information is included in one of (i) the RRC release message, or (ii) system information (SI).

15. The method of claim 14, wherein:
the NTN assistance information is included in SI; and
the method further comprises acquiring the SI including the NTN assistance information.

16. The method of claim 15, wherein:
the RRC release message further includes an indication that the indicated frequency is for an NTN frequency band; and
the method further comprises detecting the NTN cells on the indicated frequency based on the indication that the indicated frequency is for the NTN frequency band.

17. The method of claim 15, wherein the cell selection procedure is performed for RRC re-establishment based on the NTN assistance information included in the SI.

18. The method of claim 14, wherein the NTN assistance information includes a list of one or more NTN access information elements, the NTN access information elements including at least one of:
satellite ephemeris information;
common timing advance information;
epoch time;
validity duration; and
NTN polarization information.

19. The method of claim 14, wherein:
the RRC release message further includes at least one of:
synchronization signal block (SSB) subcarrier spacing for the indicated frequency; and
an SSB measurement timing configuration (SMTC) for the indicated frequency, and
the method further comprises detecting SSBs of NTN cells on the indicated frequency based on the SSB subcarrier spacing and the SMTC.

20. The method of claim 14, further comprising, prior to receiving the RRC release message, transmitting a message to the TN including an indication that the UE supports redirection from the TN to the NTN,
wherein the RRC release message includes the frequency for redirection from the TN to the NTN in response to the message indicating that the UE supports redirection from the TN to the NTN.
